(19) United States
(12) Patent Application Publication
(10) Pub. No.: US 2025/0057209 A1
(43) Pub. Date: Feb. 20, 2025

(54) POROUS SMOKING MATERIAL WRAPPER, AND SMOKING ARTICLE COMPRISING SAME

(71) Applicant: KT&G CORPORATION, Daejeon (KR)

(72) Inventors: Won Young KO, Yuseong-gu (KR); Yong Mi JUNG, Yuseong-gu (KR); Sung Min MOON, Yuseong-gu (KR); Chang Jin PARK, Yuseong-gu (KR); Hyeon Tae KIM, Yuseong-gu (KR); Ki Jin AHN, Yuseong-gu (KR)

(73) Assignee: KT&G CORPORATION, Daejeon (KR)

(21) Appl. No.: 18/717,818

(22) PCT Filed: Jun. 16, 2023
(86) PCT No.: PCT/KR2023/008362

§ 371 Date: Jun. 7, 2024

(30) Foreign Application Priority Data
Sep. 21, 2022 (KR) 10-2022-0119033

(51) Int. Cl. A24D 1/02

(52) U.S. Cl. CPC A24D 1/027

(57) ABSTRACT

There is provided a smoking material wrapper having micropores, wherein when the smoking material wrapper is divided into three regions at equal intervals from an upstream distal end based on the case where the smoking material wrapper is applied to a smoking article, an average porosity is greater as a region becomes closer to a downstream. According to an embodiment of the present disclosure, the micropores have a pore size of 10 μm to 50 μm, and are formed by a perforation method using plasma. The wrapper may maintain functionality as a wrapping material due to low visibility or the like, and may minimize a dilution ratio decreased due to burning of a smoking material unit while maintaining a basic dilution ratio when the smoking material wrapper is applied to a smoking article.

### TECHNICAL FIELD

The present invention relates to a porous smoking material wrapper and a smoking article including the same. More particularly, the present invention relates to a smoking material wrapper having micropores formed by separate perforation and a smoking article including the same.

This application claims the benefit of priority based on Korean Patent Application No. 10-2022-0119033 filed on Sep. 21, 2022, the entire contents of which are incorporated herein by reference.

### BACKGROUND ART

In general, in order to manufacture a smoking article such as tobacco delivering nicotine through burning, various types of leaf tobacco are first blended and processed to give a desired flavor and taste. The processed tobacco leaf is cut to prepare cut tobacco leaves, and the cut tobacco leaves are rolled with a smoking material wrapper (or a cigarette paper) to manufacture a filterless cigarette. Next, a filter is attached to the filterless cigarette, if necessary.

The filter may include activated carbon, a flavor material, and the like, and may be a monofilter or multiple filters. The filter is surrounded by a filter wrapper and connected to the cut tobacco leaves by a tip paper. In this case, the tip paper may include fine pores.

The smoking material wrapper may be manufactured so that target tar and target nicotine may be delivered during smoking by an appropriate porosity and burning property and further a smoking flavor unique to cigarette is imparted. Various smoking material wrappers have already been commercialized, but improvement in their functionality is still required. The present inventor has completed the present invention as a result of continuous research into smoking material wrappers.

### PRIOR ART DOCUMENT

### Patent Document

(Patent Document 1) Korean Laid-open Patent Publication No. 10-2007-0096027

### DISCLOSURE

### Technical Problem

It is an object of the present invention to provide a smoking material wrapper capable of improving functionality when the smoking material wrapper is applied to a smoking article by forming micropores in the smoking material wrapper through separate perforation, and a smoking article including the same.

### Technical Solution

According to a first aspect of the present invention, there is provided a smoking material wrapper having micropores, wherein when the smoking material wrapper is divided into three regions at equal intervals from an upstream distal end based on the case where the smoking material wrapper is applied to a smoking article, an average porosity is greater as a region becomes closer to a downstream.

In an embodiment of the present disclosure, the micropores have a pore size of 10 μm to 50 μm.

In an embodiment of the present invention, the micropores are formed by a perforation method using plasma.

In an embodiment of the present invention, a plurality of micropores are aligned in a vertical direction to constitute one set based on the case where the smoking material wrapper is applied to the smoking article, and when the smoking material wrapper is divided into the three regions at equal intervals from the upstream distal end based on the case where the smoking material wrapper is applied to the smoking article, one or more sets are included in one region.

In an embodiment of the present invention, a distance between adjacent sets is the same in an upstream and a downstream or is longer in the upstream than in the downstream based on the case where the smoking material wrapper is applied to the smoking article.

In an embodiment of the present invention, a porosity in the smoking material wrapper may be adjusted by a distance between the micropores.

In an embodiment of the present invention, a porosity in the smoking material wrapper may be adjusted by a size of the micropores.

In an embodiment of the present invention, when the smoking material wrapper is divided into the three regions at equal intervals from the upstream distal end based on the case where the smoking material wrapper is applied to the smoking article, an average pore size is smaller as the region becomes closer to the downstream.

In an embodiment of the present invention, a porosity of the smoking material wrapper at any position does not exceed 1,000 CU.

In an embodiment of the present invention, the smoking material wrapper has an average porosity of 300 CU to 700 CU.

In an embodiment of the present invention, the porosity of the smoking material wrapper increases from the upstream distal end toward the downstream based on the case where the smoking material wrapper is applied to the smoking article, and when the porosity reaches a peak, the porosity may be maintained at the peak.

In an embodiment of the present invention, the porosity of the smoking material wrapper increases in the form of a quadratic or cubic function from the upstream distal end toward the downstream based on the case where the smoking material wrapper is applied to the smoking article.

In an embodiment of the present invention, the porosity of the smoking material wrapper increases from the upstream distal end toward the downstream based on the case where the smoking material wrapper is applied to the smoking material, and reach a peak at a point of 60% to 80% of a length of the smoking material wrapper.

According to a second aspect of the present invention,
there is provided a smoking article including: a smoking material unit, a smoking material wrapper, a filter unit, a filter wrapper, and a tip paper, wherein the smoking material wrapper is the smoking material wrapper described above.

### Advantageous Effects

A smoking material wrapper according to an embodiment of the present invention basically includes micropores formed in a small size using a plasma perforation method, and thus, positions where the micropores are formed may not be easily confirmed with the naked eyes and visibility is not decreased, such that functionality of the smoking material wrapper as a wrapping material may be maintained.

In addition, even though the same level of average porosity is applied to the smoking material wrapper, it is possible to minimize a dilution ratio decreased due to burning of a smoking material unit while maintaining a basic dilution ratio when the smoking material wrapper is applied to a smoking article through an efficient arrangement of the micropores.

Accordingly, it is possible to provide a more consistent smoking satisfaction to a smoker from the start of smoking to the end of smoking.

### DESCRIPTION OF DRAWINGS

FIG. 1 is a schematic view showing a smoking article according to an embodiment of the present invention.

FIG. 2 is a schematic view showing a smoking material wrapper of which a porosity is adjusted by adjusting an interval between micropore sets aligned in a vertical direction based on the case where the smoking material wrapper is applied to the smoking article according to an embodiment of the present invention.

FIG. 3 is a schematic view showing a smoking material wrapper of which a porosity is adjusted by adjusting the number of micropores in the micropore sets aligned in the vertical direction based on the case where the smoking material wrapper is applied to the smoking article according to an embodiment of the present invention.

FIG. 4 is a schematic view showing a smoking material wrapper of which a porosity is adjusted by adjusting sizes of the micropores in the micropore sets aligned in the vertical direction based on the case where the smoking material wrapper is applied to the smoking article according to an embodiment of the present invention.

FIG. 5 is graphs illustrating porosity distributions of smoking material wrappers according to Examples 1 and 2 and Comparative Examples 1 to 5.

### BEST MODE FOR INVENTION

Hereinafter, embodiments will be described in detail with reference to illustrative drawings. It is to be noted that in giving reference numerals to components of respective drawings, the same components will be denoted by the same reference numerals even though they are illustrated in different drawings. In addition, in describing embodiments, when it is decided that a detailed description of related known configurations or functions hinders the understanding of embodiments, the detailed description will be omitted.

In addition, the terms ‘first’, ‘second’, A, B, (a), (b), and the like, may be used in describing components of embodiments. These terms are used only to distinguish one element from the other element, and the features, sequences, orders or the like of corresponding elements are not limited by these terms. When it is described that one element is “connected”, “coupled” or “accessed” to the other element, it is to be understood that the element may be directly connected or accessed to the other element or another element may be “connected”, “coupled” or “accessed” between respective elements.

One element included in any one embodiment and the element having common functions will be described using the same names in other embodiments. Unless described to the contrary, a description in any one embodiment may also be applied to other embodiments, and a detailed description will be omitted within an overlapping range.

The term “smoking article” as used herein may mean an article capable of generating an aerosol, such as a cigarette and a cigar. The smoking article may include an aerosol generating material or an aerosol forming substrate. In addition, the smoking article may include a solid material based on tobacco raw materials such as reconstituted tobacco sheet, cut tobacco leaf, and reconstituted tobacco. The smoking material may include volatile compounds. The smoking article may include several segments having each functionality, and such segments will be referred to as “˜ units”. In the present specification, the smoking article may be not only a burning-type cigarette, but also a heating-type cigarette used with an aerosol generating device (not shown) such as an electronic cigarette device.

The term “upstream” or “downstream” as used herein is a term used to indicate relative positions of the segments constituting the smoking article on the basis of a direction in which a user inhales air using the smoking article. The smoking article includes an upstream end (i.e., a portion through which air enters) and a downstream end (i.e., a portion through which air exits) facing the upstream end. The user may hold the downstream end of the smoking article between his/her lips when using the smoking article. The downstream end may be positioned downstream of the upstream end. Meanwhile, the term “end” may also be referred to as a “distal end”.

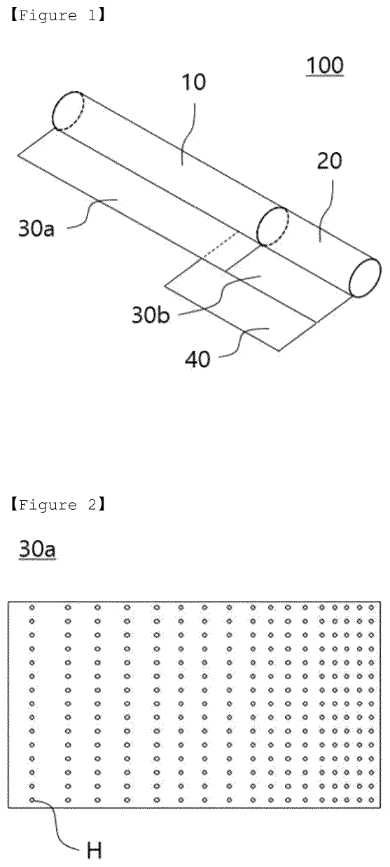

The present invention provides a smoking material wrapper used as one component of a smoking article. For reference, FIG. 1 provides a view showing a schematic configuration of a smoking article according to an embodiment of the present invention. The smoking article 100 generally includes a smoking material unit 10 and a filter unit 20. The smoking material unit 10 is surrounded and wrapped by a smoking material wrapper 30a, and the filter unit 20 is surrounded and wrapped by a filter wrapper 30b. The wrapped smoking material unit and the filter unit are connected to each other by a tip paper 40.

The smoking material wrapper 30a according to an embodiment of the present invention has functionality improved as compared with an existing smoking material wrapper by including micropores added by additional perforation, apart from natural pores basically formed on a paper material. The natural pores have a pore size of less than 10 μm, but the micropores have pores of 10 μm or more, and thus, the naturally generated pores and the micropores added artificially by perforation are clearly distinguished from each other with the naked eyes or the like.

According to an embodiment of the present invention, the micropores are formed by a perforation method using plasma. When the micropores are formed by the above-described perforation method, the micropores having a smaller and more uniform size may be formed. The smoking material wrapper 30a basically serves to wrap the smoking material unit 10, and is thus required to have high aesthetics in itself as well as functionality for preventing contents from being leaked to the outside. The micropores formed by the plasma perforation method may have a pore size of 10 to 50 μm, 15 to 50 μm, and 20 to 50 μm. When the micropores have a pore size of 50 μm or less, even though the micropores are formed, visibility of the smoking material wrapper is not significantly increased, and thus, original functionality of a wrapping material may be maintained. In addition, in the case of the plasma perforation method, a phenomenon in which paper is burned and blackened around points where the micropores are formed does not occur significantly, such that a problem that aesthetics decreases due to perforation also does not occur significantly.

In the smoking material wrapper 30a, the micropores may be formed in various sizes, positions, the numbers, and the like, but even though the same numbers of micropores are formed, a difference in functionality may occur depending on formation positions of the micropores. One of the objects of the present invention is to improve performance of a smoking article when the smoking material wrapper according to an embodiment of the present invention is applied to the smoking article by improving functionality as much as possible even though a similar number of micropores are formed.

In the present specification, a porosity is used to describe a degree of formation of the micropores. The porosity is a physical property generally used in the art in order to define a property of paper such as a smoking material wrapper, and may also be expressed as air permeability. The porosity refers to permeability of the paper to air flow due to a pressure difference between both sides of the paper, which may refer to a volume of air flowing through the paper in unit time, unit area, and pressure difference. Accordingly, the porosity may be expressed in a unit such as cm³/(min·cm²·kPa), and this unit is also expressed as a CORESTA Unit (CU), wherein 1 CU=1 cm³/(min cm²·kPa). In the present specification, a porosity and an average porosity are intentionally expressed separately, which is to clarify the fact that a deviation is great depending on a measurement position when the porosity is measured for an area greater than the unit area. Specifically, in the present specification, the porosity refers to a porosity in a unit area formed around a specific position at the specific position, and the average porosity calculated by measuring a total air permeation degree for the area greater than the unit area and then dividing the total air permeation degree by the unit area.

According to an embodiment of the present invention, when the smoking material wrapper is divided into three regions at equal intervals from an upstream distal end based on the case where the smoking material wrapper is applied to the smoking article, an average porosity is greater as a region becomes closer to the downstream. Unless the micropores are symmetrically formed in the smoking material wrapper, a direction in which the smoking material wrapper is applied to the smoking article may have a significant influence on functionality of the smoking material wrapper. Accordingly, even though the smoking material wrapper has no particular directionality in itself before being applied to the smoking article, positions in the smoking material wrapper are distinguished in consideration of directionality when the smoking material wrapper is applied to the smoking article. When the smoking material wrapper is divided into three regions at equal intervals from the upstream distal end based on the case where it is applied to the smoking article, a positional relationship between the three regions may be clearly separated and specified as the concept of the upstream and the downstream of the smoking article. When a region positioned at the most upstream among the three regions is regarded as a first region, a region positioned at the next upstream region is regarded as a second region, and a region positioned at the most downstream is regarded as a third region, an average porosity may be greater in the order of the first region, the second region, and the third region in an embodiment of the present invention. Since the third region is a portion that may remain unburned for the longest time when a smoking article is burned, it may help to improve functionality to form a plurality of micropores in the third region even though the same numbers of micropores are formed.

The micropores do not necessarily need to be formed regularly, but when the same micropores are applied to a position spaced apart by a specific distance from the upstream distal end of the smoking article, if a flow of air occurs from the upstream toward the downstream in the smoking article during smoking, the micropores may have similar functionality, so that when a plurality of micropores are aligned in a vertical direction and applied based on the case where the smoking material wrapper is applied to the smoking article, it is advantageous in grasping an influence of the formation positions of the micropores on the functionality. In addition, such a method of applying the micropores may also help improve processability. According to an embodiment of the present invention, the plurality of micropores are aligned in the vertical direction based on the case where the smoking material wrapper is applied to the smoking article to constitute one set, and when the smoking material wrapper is divided into three regions at equal intervals from the upstream distal end based on the case where the smoking material wrapper is applied to the smoking article, one or more sets are included in one region. Here, it may be strictly interpreted that the micropores are aligned in the vertical direction, but it may be regarded that the micropores are aligned in the vertical direction when it is a tendency of the micropores to be aligned in the vertical direction as a whole even though the centers of the micropores deviate from a line in the vertical direction by a size of one or two micropores.

According to an embodiment of the present invention, the micropores are continuously formed from the upstream toward the downstream. Here, the term “continuously” means that when the formation of the micropores is progressed from the upstream toward the downstream, an average distance between adjacent micropores is the same or gradually decreases. For example, when the micropores are formed with a certain tendency and are not formed in a specific region, an average distance between adjacent micropores significantly increases. In this case, it may not be regarded that the micropores are continuously formed. When the micropores are applied in the form of sets aligned in the vertical direction based on the case where the smoking material wrapper is applied to the smoking article, if the micropores are continuously formed, a distance between adjacent sets is the same in the upstream and the downstream or is longer in the upstream than in the downstream based on the case where the smoking material wrapper is applied to the smoking article.

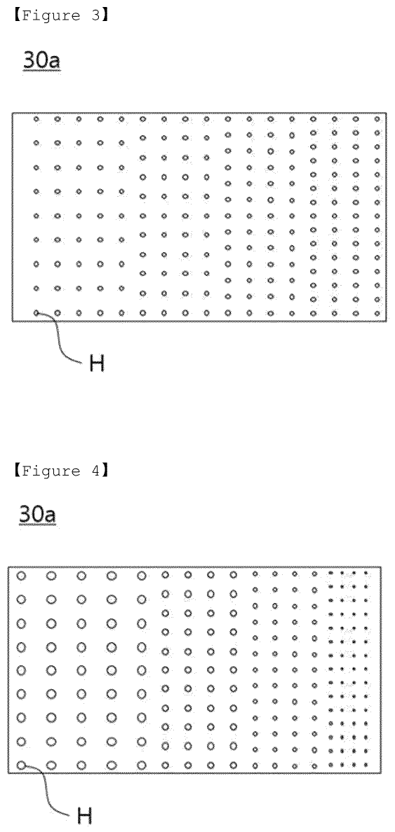

The porosity of the smoking material wrapper may be controlled in various manners. FIGS. 2 to 4 are schematic views illustrating smoking material wrappers in which the micropores are formed, and through these figures, a method of adjusting porosities in the smoking material wrappers is exemplarily confirmed. For reference, in FIGS. 2 to 4, a left direction is an upstream direction, and a right direction is a downstream direction.

In FIG. 2, after each set is composed of micropores H having the same size and the same number, the micropores are formed in a manner of decreasing a distance between the sets as the formation of the micropores is progressed from the upstream toward the downstream. When the smoking material wrapper illustrated in FIG. 2 is divided into three regions at equal intervals from the upstream distal end based on the case where the smoking material wrapper is applied to the smoking article, an average porosity is greater as a region becomes closer to the downstream.

In FIG. 3, each set is composed of micropores H having the same size, and the micropores are formed in a manner of gradually increasing the number of micropores constituting each set while maintaining a distance between the respective sets as the formation of the micropores is progressed from the upstream to the downstream. When the smoking material wrapper illustrated in FIG. 3 is divided into three regions at equal intervals from the upstream distal end based on the case where the smoking material wrapper is applied to the smoking article, an average porosity is greater as a region becomes closer to the downstream.

In FIG. 4, after each set is constituted of the same number of micropores H, the micropores are formed in a manner of simultaneously decreasing a size of the micropores and a distance between the respective sets. Even though the smoking material wrapper as illustrated in FIG. 4 is divided into three regions at equal intervals from the upstream distal end based on the case where the smoking material wrapper is applied to the smoking article, it may not be clearly defined that an average porosity is greater as a region becomes closer to the downstream, but an average porosity may be increased when an effect of increasing a porosity due to a decrease in the distance between the respective sets is greater than that of decreasing a porosity due to a decrease in the size of the micropores.

As confirmed in FIGS. 2 to 4, the porosity in the smoking material wrapper may be adjusted by the distance between the micropores and may be adjusted by the size of the micropores. Since increasing the number of micropores eventually decreases the average distance between the micropores, it may be regarded that the porosity is adjusted by the distance between the micropores. When a high porosity is required in the smoking material wrapper, the porosity may be increased by significantly decreasing the distance between the micropores while decreasing the size of the micropores. When only the distance between the micropores is decreased in a state in which the size of the micropores is a certain level or more, visibility of the smoking material wrapper may be increased, such that functionality of the smoking material wrapper as a wrapping material may be deteriorated. According to an embodiment of the present invention, when the smoking material wrapper is divided into three regions at equal intervals from the upstream distal end based on the case where the smoking material wrapper is applied to the smoking article, an average pore size is smaller as a region becomes closer to the downstream.

According to an embodiment of the present invention, the porosity of the smoking material wrapper at any position does not exceed 1,000 CU. Here, the porosity means a porosity at a specific position rather than the average porosity. Even though the average porosity is not high, when the micropores are densely positioned near a specific position, the porosity may be significantly increased. When a porosity at a specific position exceeds 1,000 CU, not only visibility at the specific position may be increased, but also durability at the specific position may be decreased, such that functionality of the smoking material wrapper as the wrapping material may be deteriorated.

According to an embodiment of the present invention, the smoking material wrapper has an average porosity of 300 CU to 700 CU, 350 CU to 650 CU, and 400 CU to 600 CU. When the average porosity is within the above range, a functionality improvement effect such as an increase in dilution ratio due to the introduction of the micropores may be exhibited, and when the average porosity exceeds the above range, not only the dilution ratio may be excessively increased, but also the durability of the smoking material unit of the smoking article may be deteriorated. As described above, even though the smoking material wrapper has the same average porosity, the functionality of the smoking material wrapper may be changed depending on the positions of the micropores, and thus, an arrangement or the like of the micropores may be important.

According to an embodiment of the present invention, the porosity of the smoking material wrapper increases from the upstream distal end toward the downstream based on the case where the smoking material wrapper is applied to the smoking article, and when the porosity reaches a peak, the porosity is maintained at the peak. It may be preferable to locate the micropores as downstream as possible in that the micropores may quickly disappear by burning when the micropores are formed close to the upstream distal end based on the case where the smoking material wrapper is applied to the smoking article. However, when the micropores are located only at the downstream, an air dilution ratio at the beginning of smoking may not be good because smoke generated through burning may not be immediately diluted with air when the smoking material is burned at a position close to the upstream distal end. Accordingly, the micropores need to be secured at a predetermined level on the entire surface of the smoking material unit, if possible. In consideration of this point, in order to secure the functionality according to the formation of the micropores as much as possible, it may be preferable to increase the porosity as the formation of the micropores moves from the upstream distal end toward the downstream and maintain the porosity at the peak when the porosity reaches the peak. Here, the peak may be freely set according to a manufacturer's design, but it may be preferable that the peak does not exceed the porosity of 1,000 CU. When the porosity does not reach the peak up to a downstream distal end of the smoking material unit, the porosity of the smoking material unit may increase steadily.

According to an embodiment of the present invention, the porosity of the smoking material wrapper increases in the form of a quadratic or cubic function as the formation of the micropores moves from the upstream distal end toward the downstream based on the case where the smoking material wrapper is applied to the smoking article. Here, the form of a quadratic or cubic function means that the porosity increases in proportion to the square of the distance or the cube of the distance. Accordingly, in the case of the form of the cubic function, even though the porosity increases in the form of a cubic function graph, a case where an inflection point does not exist at a point where a distance is 0 is excluded. Unlike a linear function, in the quadratic function or the cubic function, the porosity may rapidly increase according to a distance to reach the peak more quickly, and when the porosity reaches a peak, the porosity does not increase any more and is maintained at the peak.

According to an embodiment of the present invention, the porosity of the smoking material wrapper increases from the upstream distal end toward the downstream based on the case where the smoking material wrapper is applied to the smoking material, and reaches the peak at a point of 60% to 80% of a length of the smoking material wrapper. A decrease rate in dilution ratio may be minimized in the case where the porosity is maintained at a certain level of peak as compared with the case where the porosity reaches the peak too soon or reaches the peak too late.

As described above, the functionality secured by forming the micropores may be further magnified through a combination with other components of the smoking article. Other technical features of the smoking article excluding a technical feature of the formation of the micropores may be easily combined and used within a range generally known in the art.

The smoking material unit 10 wrapped by the smoking material wrapper 30a may be filled with a smoking material such as raw leaf tobacco, reconstituted tobacco sheet, or a mixture of leaf tobacco and reconstituted tobacco sheet. The processed smoking material may be filled in the smoking material unit 10 in the form of a sheet or cut tobacco leaves. The smoking material unit 10 may have a rod shape extended to be elongated, and a length, a circumference, and a diameter of the smoking material unit 10 are not particularly limited, but may be adjusted to a size generally used in the art in consideration of an amount of smoking material filled in the smoking material unit 10, user's taste, and the like. The smoking material unit 10 may include at least one aerosol generating material selected from glycerin, propylene glycol, ethylene glycol, dipropylene glycol, diethylene glycol, triethylene glycol, tetraethylene glycol, and oleyl alcohol. The smoking material unit 10 may contain other additives such as flavoring agents, humectants, and/or acetate compounds. The aerosol generating material and the additives may be contained in the smoking material.

In addition to the smoking material unit 10, the filter unit 20 constituting the smoking article 100 is disposed downstream of the smoking material unit 10, and serves as a filter through which an aerosol material generated from the smoking material unit 10 passes immediately before it is inhaled by the user. The filter unit 20 may be made of various materials. For example, the filter unit 20 may be a cellulose acetate filter. The filter unit 20 may be a cellulose acetate filter to which a fragrance material is not added or be a transfer jet nozzle system (TJNS) filter to which a fragrance material is added.

According to an embodiment of the present invention, the filter unit 20 may be a tubular structure including a hollow formed therein. The filter unit 20 may be manufactured by inserting a structure such as a film or a tube made of a homogeneous or heterogeneous materials into an inner portion (e.g., a hollow) thereof. It has been shown in FIG. 1 that the filter unit 20 according to an embodiment of the present invention is a mono filter composed of a single filter, but the present invention is not limited thereto. For example, the filter unit 20 may also be a dual filter, a triple filter, or the like, including two acetate filters in order to increase filter efficiency. In addition, although not shown, a crushable capsule (not shown) having a structure in which an inner liquid including a fragrance is surround by a film may be included inside the filter unit 20.

The smoking material unit 10 may be wrapped by the above-described smoking material wrapper 30a. Some of the cigarette smoke generated in a burning process of a general smoking material unit 10 are released into the air through the smoking material unit wrapper 30a before passing through a cigarette filter, and sidestream smoke gives passive smokers an unpleasant feeling. Conventionally, various attempts such as an attempt to add a filler such as magnesium oxide, titanium oxide, cerium oxide, aluminum oxide, calcium carbonate, or zirconium carbonate to a cigarette paper in order to reduce such sidestream smoke have been made, but when the sidestream smoke is reduced by simply applying such a filler, a decrease in smoking flavor feeling, burning-off, a decrease in ash integrity, and the like, have occurred. Therefore, it has been difficult to solve the above-described problem through an appropriate combination of materials included in the filler. In the smoking material wrapper 30a according to an embodiment of the present invention, a filler in which magnesium oxide (MgO and/or Mg(OH)₂) and calcium carbonate (CaCO₃) are mixed is applied in order to prevent the decrease in smoking flavor feeling, the decrease in ash integrity, and the burning-off while reducing the sidestream smoke.

The filter unit 20 may be wrapped by the filter wrapper 30b. The filter wrapper 30b may be made of wrapping paper having oil resistance, and aluminum foil may be further included on an inner surface of the filter wrapper 30b.

The smoking material unit 10 wrapped by the smoking material wrapper 30a and the filter unit 20 wrapped by the filter wrapper 30b may be coupled and wrapped by the tip paper 40. The tip paper 40 may wrap the outside of at least a portion (for example, a downstream partial region) of the smoking material wrapper 30a and the filter wrapper 30b, as shown in FIG. 1. In other words, at least a portion of the smoking material unit 10 and the filter unit 20 may be further wrapped and physically coupled by the tip paper 40. According to an embodiment of the present invention, the tip paper 40 may be made of non-porous wrapping paper on which oil resistance treatment is not performed, but is not limited thereto. In addition, the tip paper 40 may prevent a phenomenon in which the filter unit 20 is burned by including a noninflammable material, but is not limited thereto.

Hereinafter, a configuration of the present invention and its effect will be described in more detail through Examples and Comparative Examples. However, these examples are provided in order to describe the present invention in more detail, and the scope of the present invention is not limited to these examples.

### EXAMPLES

### Example 1

For the Example, a smoking material wrapper surrounding a smoking material unit of a smoking article manufactured for a test was removed, and micropores having a size of about 30 μm were formed in the same type of smoking material wrapper using a plasma perforation device (a product manufactured by Tann papier company). The micropores were formed so that an average porosity of the smoking material wrapper was 500 CU, and were formed so that a porosity of the smoking material wrapper was increased according to a quadratic function as a distance from an upstream distal end was increased based on the case where the smoking material wrapper is applied to the smoking article. The porosity reached 1,000 CU at a point of about 39 mm from the upstream distal end, and was maintained at 1,000 CU after that point. The smoking article was manufactured by adhering the smoking material wrapper in which the micropores were formed to the smoking material unit so as to surround the smoking material unit again. In the smoking article, a length of the smoking material unit in an axial direction was about 51 mm and a circumference of the smoking material unit was about 23.7 mm.

### Example 2

A smoking article was manufactured in the same manner as in Example 1, except that micropores were formed in a pattern different from that of Example 1. Specifically, in Example 2, the micropores were formed so that an average porosity of the smoking material wrapper was 500 CU, and were formed so that a porosity of the smoking material wrapper was increased according to a cubic function as a distance from an upstream distal end was increased based on the case where the smoking material wrapper is applied to the smoking article. The porosity reached 1,000 CU at a point of about 34 mm from the upstream distal end, and was maintained at 1,000 CU after that point.

### Comparative Example 1

A smoking article was manufactured in the same manner as in Example 1, except that micropores were formed in a pattern different from that of Example 1. Specifically, in Comparative Example 1, the micropores were formed so that an average porosity of the smoking material wrapper was 500 CU, and were formed so that a porosity of the smoking material wrapper was constantly maintained at 500 CU even though a distance from an upstream distal end was increased based on the case where the smoking material wrapper is applied to the smoking article.

### Comparative Example 2

A smoking article was manufactured in the same manner as in Example 1, except that micropores were formed in a pattern different from that of Example 1. Specifically, in Comparative Example 2, the micropores were formed so that an average porosity of the smoking material wrapper was 500 CU, and were formed so that a porosity of the smoking material wrapper was increased according to a linear function as a distance from an upstream distal end was increased based on the case where the smoking material wrapper is applied to the smoking article. The porosity reached 1,000 CU at a point of about 51 mm from the upstream distal end.

### Comparative Example 3

A smoking article was manufactured in the same manner as in Example 1, except that micropores were formed in a pattern different from that of Example 1. Specifically, in Comparative Example 3, the micropores were formed so that an average porosity of the smoking material wrapper was 500 CU, and were formed so that a porosity of the smoking material wrapper was increased according to a cubic function having a form different from that of Example 2 as a distance from an upstream distal end was increased based on the case where the smoking material wrapper is applied to the smoking article. Unlike Example 2, the cubic function of Comparative Example 3 was adjusted so that an inflection point of the cubic function existed at a point of about 25.5 mm from the upstream distal end, and the porosity reached 1,000 CU at a point of about 51 mm from the upstream distal end.

### Comparative Example 4

A smoking article was manufactured in the same manner as in Example 1, except that micropores were formed in a pattern different from that of Example 1. Specifically, in Comparative Example 4, the micropores were formed so that an average porosity of the smoking material wrapper was 500 CU, and were formed so that a porosity of the smoking material wrapper was increased as a distance from an upstream distal end was increased by connecting curved lines of different patterns on the basis of a point of about 25.5 mm from the upstream distal end. The porosity reached 1,000 CU at a point of about 51 mm from the upstream distal end.

### Comparative Example 5

A smoking article was manufactured in the same manner as in Example 1, except that micropores were formed in a pattern different from that of Example 1. Specifically, in Comparative Example 5, the micropores were formed so that an average porosity of the smoking material wrapper was 500 CU, and were formed so that a porosity of the smoking material wrapper was increased according to an exponential function as a distance from an upstream distal end was increased based on the case where the smoking material wrapper is applied to the smoking article. The porosity reached 1,000 CU at a point of about 27 mm from the upstream distal end, and was maintained at 1,000 CU after that point.

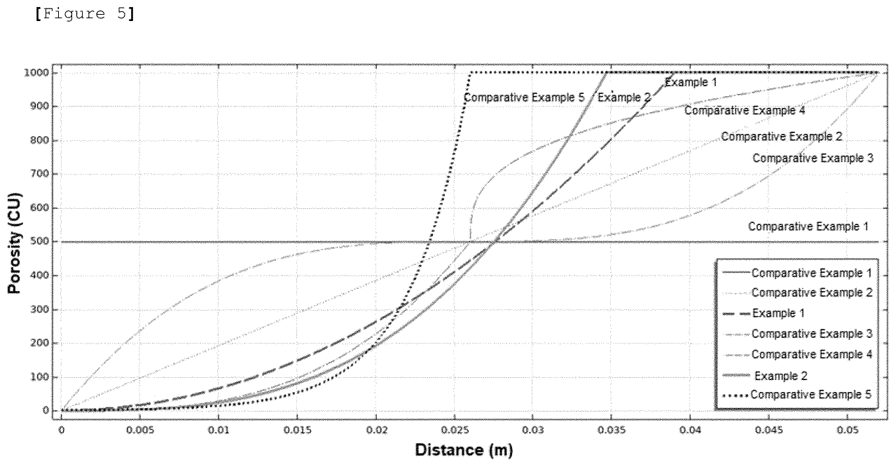

Specific porosity distribution of the smoking material wrappers according to Examples 1 and 2 and Comparative Examples 1 to 5 were illustrated in FIG. 5 below. In FIG. 5, a distance of an X axis refers to a distance from the upstream distal end based on the case where the smoking material wrapper is applied to the smoking article. For example, a distance of 0 m refers to a position at the upstream distal end based on the case where the smoking material wrapper is applied to the smoking article, and a distance of 0.025 m refers to a position at a distance of 25 mm from the upstream distal end based on the case where the smoking material wrapper is applied to the smoking article.

### Experimental Example

Physical properties of respective smoking articles manufactured according to Examples 1 and 2 and Comparative Examples 1 to 5 were analyzed using a cigarette physical property measuring device (a Cigarette Quality Tester manufactured by Kardien company). The physical property analysis was performed when a point of 51 mm (3/3 point), a point of 34 mm (2/3 point), and a point of 17 mm (1/3 point) of the smoking material unit remained, respectively. In the physical property analysis, dilution ratios of all components were evaluated based on the case where the micropores were not formed, and the evaluation results were illustrated in Table 1 below.

TABLE 1

| | Dilution ratio | | | Change in dilution ratio | |
|---|---|---|---|---|---|
| | 51 mm | 34 mm | 17 mm | (3/3 point → 1/3 point) | |
| | (3/3 | (2/3 | (1/3 | Decreasing | Decreasing |
| | point) | point) | point) | amount | rate |
| Example 1 | 71.33% | 55.53% | 24.34% | 46.99% | 65.9% |
| Example 2 | 71.59% | 56.43% | 24.44% | 47.15% | 65.9% |
| Comparative | 63.64% | 40.61% | 13.64% | 50.00% | 78.6% |
| Example 1 | | | | | |
| Comparative | 70.14% | 52.36% | 22.19% | 47.95% | 68.4% |
| Example 2 | | | | | |
| Comparative | 68.13% | 47.87% | 19.54% | 48.58% | 71.3% |
| Example 3 | | | | | |
| Comparative | 71.37% | 55.65% | 23.59% | 47.78% | 66.9% |
| Example 4 | | | | | |
| Comparative | 81.53% | 57.11% | 24.44% | 57.09% | 70.0% |
| Example 5 | | | | | |

According to Table 1 above, even though the average porosities of the smoking material wrappers were adjusted to be the same in the Examples and the Comparative Examples, the dilution ratio became different at respective points depending on patterns of the micropores. It may be important to minimize a decrease in dilution ratio according to the progress of smoking in that a more consistent smoking satisfaction may be provided to a smoker from the start of smoking to the end of smoking. In this regard, when the porosity is increased in the form of the quadratic or cubic function from the upstream distal end of the smoking material as in Examples 1 and 2, the decrease in dilution ratio may be minimized even though the smoking material wrapper has the same average porosity.

Embodiments have been described hereinabove by restrictive examples and drawings, but various modifications and variations may be made from the above description by those skilled in the art. For example, even though the described technologies are performed in an order different from that of the described method and/or components of the described system, structure, device, circuit, and the like, may be coupled to or combined in a form different from that of the described method, or are replaced by other components or their equivalents, appropriate results may be achieved.

### DESCRIPTION OF SYMBOLS

10: Smoking material unit
20: Filter unit
30a: Smoke material wrapper
30b: Filter wrapper
40: Tipp paper
100: Smoking article
H: micropore

1. A smoking material wrapper having micropores, wherein when the smoking material wrapper is divided into three regions at equal intervals from an upstream distal end based on the case where the smoking material wrapper is applied to a smoking article, an average porosity is greater as a region becomes closer to a downstream.

2. The smoking material wrapper of claim 1, wherein the micropores have a pore size of 10 μm to 50 μm.

3. The smoking material wrapper of claim 1, wherein the micropores are formed by a perforation method using plasma.

4. The smoking material wrapper of claim 1, wherein a plurality of micropores are aligned in a vertical direction to constitute one set based on the case where the smoking material wrapper is applied to the smoking article, and
when the smoking material wrapper is divided into the three regions at equal intervals from the upstream distal end based on the case where the smoking material wrapper is applied to the smoking article, one or more sets are included in one region.

5. The smoking material wrapper of claim 4, wherein a distance between adjacent sets is the same in an upstream and a downstream or is longer in the upstream than in the downstream based on the case where the smoking material wrapper is applied to the smoking article.

6. The smoking material wrapper of claim 1, wherein a porosity in the smoking material wrapper is adjusted by a distance between the micropores.

7. The smoking material wrapper of claim 1, wherein a porosity in the smoking material wrapper is adjusted by a size of the micropores.

8. The smoking material wrapper of claim 1, wherein when the smoking material wrapper is divided into the three regions at equal intervals from the upstream distal end based on the case where the smoking material wrapper is applied to the smoking article, an average pore size is smaller as the region becomes closer to the downstream.

9. The smoking material wrapper of claim 1, wherein a porosity of the smoking material wrapper at any position does not exceed 1,000 CU.

10. The smoking material wrapper of claim 1, wherein the smoking material wrapper has an average porosity of 300 CU to 700 CU.

11. The smoking material wrapper of claim 9, wherein the porosity of the smoking material wrapper increases from the upstream distal end toward the downstream based on the case where the smoking material wrapper is applied to the smoking article, and when the porosity reaches a peak, the porosity is maintained at the peak.

12. The smoking material wrapper of claim 11, wherein the porosity of the smoking material wrapper increases in the form of a quadratic or cubic function from the upstream distal end toward the downstream based on the case where the smoking material wrapper is applied to the smoking article.

13. The smoking material wrapper of claim 9, wherein the porosity of the smoking material wrapper increases from the upstream distal end toward the downstream based on the case where the smoking material wrapper is applied to the smoking material, and reaches a peak at a point of 60% to 80% of a length of the smoking material wrapper.

14. A smoking article, comprising:
a smoking material unit;
a smoking material wrapper;
a filter unit;
a filter wrapper; and
a tip paper,
wherein the smoking material wrapper is the smoking material wrapper of claim 1.
